(19) United States
(12) Patent Application Publication
(10) Pub. No.: US 2013/0108543 A1
(43) Pub. Date: May 2, 2013

(54) METHOD FOR PRODUCING CHROMIUM (III) OXIDE

(71) Applicants: Holger Friedrich, Newcastle (ZA); Rainer Ortmann, Koln (DE); Matthias Stenger, Monheim (DE); Daniel Van Rooyen, Newcastle (ZA); Naveen Kalideen, Newcastle (ZA); Matthias Boll, Koln (DE)

(72) Inventors: Holger Friedrich, Newcastle (ZA); Rainer Ortmann, Koln (DE); Matthias Stenger, Monheim (DE); Daniel Van Rooyen, Newcastle (ZA); Naveen Kalideen, Newcastle (ZA); Matthias Boll, Koln (DE)

(73) Assignee: LANXESS Deutschland GmbH, Leverkusen (DE)

(21) Appl. No.: 13/518,111

(22) PCT Filed: Dec. 8, 2010
(86) PCT No.: PCT/EP2010/069211

§ 371 Date: Jan. 18, 2013

(30) Foreign Application Priority Data
Dec. 22, 2009 (EP) 09180385.8

(51) Int. Cl. C01G 37/033

(52) U.S. Cl. CPC C01G 37/033
USPC 423/607

(57) ABSTRACT

Process for preparing chromium(III) oxide, comprising the steps of:
a) Decomposing an alkali metal ammonium chromate double salt at a temperature of 200 to 650° C., especially of 250 to 550° C.,
b) washing the decomposition product obtained after a) and
c) calcining the product obtained after b) at a temperature of 700 to 1400° C., especially of 800 to 1300° C.

The invention relates to a process for preparing chromium(III) oxide, to the use of the chromium(III) oxide thus prepared for various applications, and to a process for preparing specific alkali metal ammonium chromate double salts.

Chromium(III) oxide is a versatile product with a wide range of applications. For instance, it can be used as a pigment for colouring different application media, for example building materials, plastics, paints and coatings, glasses or ceramics. For this field of use, a minimum content of water-soluble impurities is required.

In addition, chromium(III) oxide is also used in abrasives and high-temperature-resistant materials. For the use of chromium(III) oxide in high-temperature-resistant materials, a minimum alkali metal content is desired in order to as far as possible suppress the oxidation of Cr(III) to alkali metal chromate, which is favoured at high temperatures in the presence of alkali metal ions.

A further important field of industrial use for chromium(III) oxide is use as a starting material for the production of chromium metal and/or chromium-containing high-performance alloys. It is generally possible here to use only chromium(III) oxides which feature a low sulphur content and a low carbon content. The term “low-sulphur chromium(III) oxide” is therefore frequently used as a synonym for “chromium(III) oxide for metallurgical purposes”.

According to the prior art, chromium(III) oxide can be prepared by various processes. It is usually prepared from hexavalent chromium compounds at elevated temperatures, and different degrees of purity can be achieved. The starting compounds of hexavalent chromium used are chromic acid, ammonium chromates or alkali metal chromates. The reaction can be carried out with or without addition of a reducing agent. The reducing agents used are organic or inorganic reducing agents, such as sawdust, molasses, cellulose waste liquors, acetylene, methane, sulphur and compounds thereof, phosphorus, carbon, hydrogen and the like. Such processes are described in numerous property rights. By way of example, mention shall be made merely of U.S. Pat. No. 1,893,761 and DE-A-20 30 510. U.S. Pat. No. 1,893,761 discloses the preparation of chromium(III) oxide by the reduction of alkali metal chromates with organic substances. In the case of use of carbon or organic compounds as the reducing agent, the process can be conducted such that sodium carbonate is ultimately obtained as a by-product, as already mentioned in U.S. Pat. No. 1,893,761. This can optionally be recycled into the process for producing sodium dichromate when the sodium dichromate is prepared via an oxidative alkaline digestion proceeding from chromium ore. However, the chromium(III) oxide obtained in this way contains a high carbon content which makes it unsuitable for metallurgical use. DE-A-20 30 510 describes a process for continuously preparing very pure, low-sulphur chromium(III) oxide by reducing alkali metal chromates with hydrogen at relatively high temperatures, and an apparatus suitable therefor. The reaction temperature is between 1000-1800° C., advantageously between 1100-1400° C., and the product obtained is separated from the offgas with the aid of an alkalized dispersion. A disadvantage of all these processes which work with a reducing agent is, however, that the use of the reducing agent inevitably results in a by-product which has to be worked up.

The thermal decomposition of pure ammonium dichromate, in contrast, does not itself lead to any significant inevitable occurrence of a by-product, since it ideally proceeds according to the reaction equation:

(NH₄)₂Cr₂O₇→Cr₂O₃+N₂+4H₂O (1)

from a temperature of approx. 200° C. However, the industrial processes nowadays being practised for preparation of ammonium dichromate proceed from alkali metal dichromates—usually sodium dichromate. In this case, the sodium dichromate is reacted with ammonium chloride or ammonium sulphate to give ammonium dichromate and sodium chloride, or to give ammonium dichromate and sodium sulphate. Chromium(III) oxide for metallurgical purposes used to be produced industrially by calcining, in a furnace, a mixture of ammonium dichromate and sodium chloride, which was obtained by in situ reaction of sodium dichromate and ammonium chloride in virtually stoichiometrically equivalent amounts. The calcination temperature should be above 700° C. in order to ensure that the reaction mixture has a high chromium(III) oxide content; at too high a temperature, however, there is an increasing risk of slag formation in the furnace, and the temperature is therefore generally kept below 850° C.

The use of ammonium sulphate instead of ammonium chloride is frequently preferred since ammonium chloride, owing to its low sublimation temperature, sublimes off in the form of NH₃ and HCl in the course of calcination, and can thus get into the waste air. For this reason, the use of ammonium chloride is no longer of any economic significance. However, the disadvantage of use of ammonium sulphate is that sulphur is entrained into the production process in this way, even though a chromium(III) oxide with a minimum sulphur content is desired.

DE-A-26 35 086 (US-A-4235862) discloses a process for preparing a low-sulphur chromium(III) oxide, which is characterized by calcination of a mixture of alkali metal dichromate and ammonium sulphate at a calcination temperature of 800 to 1100° C. and removal of the chromium(III) oxide formed from alkali metal salt formed, using 0.7 to 0.89 and preferably 0.7 to 0.84 mol of ammonium sulphate per mole of alkali metal chromate. After the calcination, the chromium(III) oxide is worked up in a conventional manner by washing out water-soluble salts and drying. After this process, sulphur contents in the chromium(III) oxide of 50 to 100 ppm can be achieved. A disadvantage of this process is that, to achieve low sulphur contents, the starting substances must not be mixed in a stoichiometric ratio, and ammonium sulphate is used in a distinct deficiency. This results in low conversions in the region of approx. 90%, and maintenance of a high calcination temperature is required. The alkali metal dichromate present owing to the excess decomposes thermally to alkali metal chromate, chromium(III) oxide and oxygen. Thus, the reaction gives rise not only to a large amount of alkali metal sulphate (for example sodium sulphate) but also always alkali metal chromate (for example sodium chromate), which gets into the mother liquor or washing liquid in the course of later washing, and then has to be removed in order to recycle it into the process if appropriate. The mother liquor, however, then also contains the alkali metal sulphate which is inevitably obtained and has to be purified in a complex manner since it is always contaminated with alkali metal chromate. Moreover, the conditions proposed for preparation of low-sulphur chromium(III) oxide have been found to be difficult to implement in practice, since the sodium sulphate content of the reaction mixture leads to caking at the high temperatures required (melting temperature of sodium sulphate approx. 885° C.) and hence to disruption in the production cycle.

For preparation of chromium(III) oxide with relatively low sulphur contents, U.S. Pat. No. 4,296,076 (FR-A-2414477 =DE-A-2901736) discloses a process in which, inter alia, sodium dichromate and ammonium chloride or sodium dichromate and ammonium sulphate are used. In contrast to DE-A-26 35 086, in this case, essentially a stoichiometric ratio is selected or, preferably, an excess of the ammonium compound is used. In a first reaction step, the starting compounds are converted to ammonium dichromate and sodium chloride or ammonium dichromate and sodium sulphate. In the examples disclosed, this reaction step takes place at 400 to 800° C., followed by the aqueous workup and then by a second calcination process at a temperature above 1100° C. According to this process, sulphur contents in the chromium(III) oxide of below 40 ppm are achieved. In this process, however, large amounts of sodium chloride or sodium sulphate are obtained, which have to be purified in a complex manner. Moreover, the use of the ammonium compounds mentioned, especially of ammonium chloride, is not unproblematic because they sublime very readily and can thus get into the offgas air.

Another process described in the prior art for preparing high-quality chromium(III) oxide is disclosed in RU 2 258 039. Although ammonium dichromate—obtained by reaction of sodium dichromate with ammonium sulphate in the aqueous phase—is used here too for the preparation of chromium(III) oxide, the sodium sulphate inevitably obtained in the reaction is removed from the reaction mixture, such that a relatively pure, i.e. low-sulphur, ammonium dichromate is decomposed thermally to chromium(III) oxide. Sodium sulphate is always obtained as a by-product, which has to be purified in a complex manner since it is contaminated with Cr(VI).

The thermal decomposition of pure chromic acid (2) is described, inter alia, in the literature as the reaction (for example Ullmann's Encyclopedia of Industrial Chemistry, Vol. A7, page 87, VCH Verlag, 1986)

4CrO₃+2Cr₂O₃+3O₂ (2)

Also in the case of chromic acid as a starting material for preparation of chromium(III) oxide, alkali metal chromates are generally reacted in a first step with sulphuric acid and/or hydrogen sulphate-containing compounds to give alkali metal dichromates (3) and then converted with further sulphuric acid to chromic acid (4).

2Na₂CrO₄+H₂SO₄→Na₂Cr₂O₇+Na₂SO₄+H₂O (3)

Na₂Cr₂O₇+H₂SO₄→2CrO₃+Na₂SO₄+H₂O (4)

Consequently, these processes for preparing chromium(III) oxide also give considerable amounts of alkali metal sulphates, for example sodium sulphate, as by-products. In the process mentioned, the thermal decomposition of pure chromic acid proceeding from sodium chromate, approximately 1.9 kg of sodium sulphate (combination of (3), (4) and (2)) form per kilogram of chromium(III) oxide. The sodium sulphate is always contaminated with sodium chromate, such that it is of inferior quality and first has to be purified in a complex manner before being brought to market. Moreover, chromic acid is a very strong oxidizing agent and an extremely corrosive compound. The handling thereof in industrial processes at elevated temperatures is correspondingly difficult.

For preparation of low-sulphur chromium(III) oxide, there are also descriptions of other processes in which substantially sulphur- and carbon-free starting materials are used.

In DE-A-28 52 198 (U.S. Pat. No. 4,230,677), the preparation of ammonium monochromate is effected by reaction of sodium dichromate or sodium monochromate by means of a solvent extraction from an organic solvent. The subsequent calcination to chromium(III) oxide is effected at 500° C. A disadvantage of this method is that very highly diluted aqueous solutions are employed. For instance, the concentration of chromium—calculated as Cr₂O₃—in the aqueous solution to be extracted is in the range from 1 g/l to 25 g/l, a particularly preferred concentration specified being 8.2 g/l. Even in the organic phase, it is possible after two extractions to achieve only a Cr₂O₃ concentration of 10 g/l. As a result, it is necessary to handle, reprocess and circulate very large amounts of liquid. The organic solvents used are benzene, xylene or toluene, alone or mixed with an isoparaffinic hydrocarbon. All these substances are hazardous substances since they are inflammable, and so extensive measures have to be taken to protect employees and the environment when this process is practised. In addition, the extraction takes place at a pH between 1 and 2, for which hydrochloric acid is used. This forms a not inconsiderable amount of sodium chloride, which pollutes the wastewater. All of the organic solvents used have a noticeable water solubility (solubilities at 20° C. in water: benzene 1.77 g/l, toluene 0.47 g/l, xylene 0.2 g/l), and so the wastewater is additionally accompanied by a high burden of organic compounds and has to be purified in a complex manner. Owing to its numerous disadvantages, this process has not gained any economic significance to date.

The thermal treatment of sodium dichromate at relatively high temperatures leads to chromium(III) oxide even in the absence of a reducing agent. For instance, Na₂Cr₂O₇*2H₂O decomposes, according to the studies by S. Sampath et al. (Thermochimica Acta, 159 (1990), p. 327-335) slowly from a temperature of 500° C. to Na₂CrO₄ and Cr₂O₃.

4Na₂Cr₂O₇*2H₂O→4Na₂CrO₄+2Cr₂O₃+3O₂+8H₂O (5)

According to the chemical reaction equation, ideally not more than 50 mol % of the Cr(VI) used is converted to chromium(III) oxide. During the heating operation, at 83° C., sodium dichromate containing water of crystallization is first converted to the anhydrous compounds. The sodium dichromate free of water of crystallization melts at 357° C., and so the decomposition takes place in the melt. This once again significantly lowers the conversion in the reaction. The reaction rate is still very low at 500° C., and so higher temperatures have to be employed in order to achieve acceptable reaction rates. For example, in the decomposition of anhydrous sodium dichromate at 750° C., only approx. 25 mol % of Cr(VI) is converted to Cr₂O₃. As a result of the low yield, this process is of no interest on the industrial scale for the preparation of chromium(III) oxide.

In CN-A-1310132, ammonium chromate is prepared by conversion of sodium chromate in the presence of carbon dioxide and ammonia. The ammonium chromate prepared by this process is said to be usable for the preparation of chromium(III) oxide. However, the process disclosed for preparation of ammonium chromate has several disadvantages. Firstly, the sodium chromate solution used has to be recrystallized and filtered at the start. Thus, a purification step—which is described only incompletely—is required, in which sodium chloride is obtained as a by-product. Secondly, the reaction with carbon dioxide and ammonia proceeds in two process steps, in each of which carbon dioxide and ammonia are added. The sodium hydrogen carbonate formed after the first reaction is removed by cold crystallization, the cooling rate being 1° C./h to 4° C./h. As a result, the crystallization is a very slow and time-consuming process, especially given that a two-hour ageing step also precedes the filtration in all examples disclosed. The conditions under which chromium(III) oxide is supposed to be prepared from the ammonium chromate obtained are not, however, disclosed in CN-A-1310132.

The use of pure ammonium chromate or ammonium dichromate for the thermal decomposition to prepare pure chromium(III) oxide is generally not uncritical, since the decomposition in the dry state can proceed explosively. Ammonium dichromate is therefore also classified as a hazardous substance with the hazard symbol “E” (explosive). The decomposition reaction is accordingly difficult to control. The Cr₂O₃ decomposition product obtained from this reaction is notable for an extremely low bulk density, which may be within the range from 0.1 to 0.2 g/cm³. As a result, the Cr₂O₃ decomposition product obtained has a very high tendency to dust. In an industrial process, the waste air has to be freed of a large amount of dust. The dust also contains as yet unconverted proportions of Cr(VI).

CN-A-1418822 discloses the simultaneous preparation of alkali metal dichromates and chromium(III) oxide, which is characterized in that an alkali metal chromate is mixed with ammonium chromate or ammonium dichromate in a molar ratio of alkali metal chromate:ammonium chromate or ammonium dichromate=(0.3-3):1, and the mixture is calcined within the temperature range from 650° C. to 1200° C. for 0.5 to 3 hours. The calcined product is dissolved in water. After a solid/liquid separation, the solid residue consists of low-sulphur chromium(III) oxide. Alkali metal dichromate is crystallized out of the concentrated mother liquor by cooling. The solid alkali metal dichromate is removed via a solid/liquid separation from unreacted alkali metal chromate. In the examples disclosed, mixtures of sodium chromate (Na₂CrO₄*4H₂O) and ammonium chromate, sodium chromate (Na₂CrO₄) and ammonium dichromate, potassium chromate (K₂CrO₄) and ammonium chromate, and potassium chromate (K₂CrO₄) and ammonium dichromate are used. The yield of chromium(III) oxide in relation to the Cr(VI) present in the starting mixtures varies between 36 and 40% in Examples 1 to 3. Moreover, the reaction product as obtained, for example, from Examples 1 and 2 is very tacky. This makes industrial implementation very difficult, for example by means of a rotary tube furnace.

Otherwise, the ammonium chromate is used in the examples in a maximum ratio of 1:1 to the alkali metal chromate, or in a stoichiometric deficiency.

CN1418821 discloses that sulphur-free chromium oxide can be obtained by calcination at 650-1200° C. of a 1:1 ammonium chromate alkali metal double salt. However, the disadvantage in the process described therein is that the yield of chromium oxide is only around 23% in relation to the Cr(VI) present in the starting compound, and the process is therefore not an economically viable method for obtaining chromium oxide. Even taking into account that the double salts used in the examples of the present application have an NH₄:Na ratio of 3:1 instead of 1:1, a yield of 34.5% based on the starting material would have to be obtained from the same amount. Instead, an average of approx. 60% is obtained, which constitutes a considerable improvement over the prior art. A further disadvantage is that the sodium content—calculated as sodium metal—in the chromium oxide obtained is very high at 1900 ppm. Moreover, the reaction mixture is found to be very tacky from a temperature of approx. 700° C., at which the calcination takes place, which especially makes industrial implementation very difficult, for example by means of a rotary tube furnace.

It was an object of the invention to find a process for preparing chromium oxide, which is economically utilizable and additionally gives a chromium oxide which is usable for metallurgical purposes, i.e. especially has a low sulphur content and alkali metal content, especially sodium content, and a very low level of by-products.

The invention therefore relates to a process for preparing chromium(III) oxide, comprising the steps of:
a) decomposing an alkali metal ammonium chromate double salt at a temperature of 200 to 650° C., especially of 250 to 550° C.,
b) washing the decomposition product obtained after a) and
c) calcining the product obtained after b) at a temperature of 700 to 1400° C., especially of 800 to 1300° C., characterized in that the alkali metal ammonium chromate double salt comprises a sodium ammonium chromate double salt which has a molar ammonium:sodium ratio of ≧2.

### Step a)

For the process according to the invention, it is possible to use the compounds already mentioned in the literature NaNH₄CrO₄*2H₂O (Acta-Phys.-Chem. Sin, 21 (2) 2005, p. 218-220 or Trudy po Khimii i Khimicheskoi Technologii (3) 1966, p. 20-6) or KNH₄CrO₄ as starting material. Preference is given especially to alkali metal ammonium chromate double salts of the composition

Mₓ(NH₄)_{y}CrO₄

or hydrates thereof, in which
M is Na or K, more preferably Na,
x is from 0.1 to 0.9, preferably from 0.4 to 0.7,
y is from 1.1 to 1.9, preferably from 1.3 to 1.6, and the sum of x and y is 2.

Particular preference is given to using an alkali metal ammonium chromate double salt which is a sodium ammonium chromate double salt which has a molar ammonium:sodium ratio of >1, especially of >2.

The double salts may also be present in the form of hydrates, but this is unimportant for the process according to the invention.

The alkali metal ammonium chromate double salts used in accordance with the invention are preferably used in pure form (100%). However, it is also possible to use mixtures of one or more alkali metal ammonium chromate double salts with alkali metal chromates or alkali metal dichromates. These mixtures contain preferably less than 10% by weight, especially less than 5% by weight, more preferably less than 2% by weight, of further alkali metal chromates or alkali metal dichromates, and the alkali metal chromates or alkali metal dichromates may be in anhydrous form or in the form of their hydrates.

The double salt NaNH₄CrO₄*2H₂O described in CN-A-1418821 crystallizes in the space group P2₁2₁2₁ with the lattice parameters a=841.3(5) pm, b=1303.9(8) pm and c=621.9(4) pm, and Z=4, and is isostructural to NaNH₄SO₄*2H₂O (Acta Cryst., B28 1972, p. 683-93). The double salt preferably used in the process according to the invention, in contrast, crystallizes hexagonally in the P-3m1 space group. With the aid of X-ray structural analysis, the crystal structure was elucidated on a single crystal (lattice parameters a=598.770(10) pm, b=598.770(10) pm and c=779.050(10) pm, and Z=2). A powder diffractogram simulated using the single crystal data has very good agreement with the powder diffractogram measured for the overall sample, but very strong texture effects can also occur in the powder diffractogram. Viewed in idealized form, the molar anunonium:sodium ratio in this crystal structure is 3. In fact, there may, however, be deviations in the stoichiometry, for example resulting from defects, such that the ratio of ammonium to alkali metal, especially sodium, is 1.3 to 1.6:0.4 to 0.7 in the same crystal structure. This can also lead to variations in the lattice parameters. If alkali metal chromate and ammonium chromate crystallized out of solutions or melts to form this particular crystal lattice which contains the ions of both compounds, what is present is, for example, a double salt within the meaning of this invention. In the case of dissolution in a sufficient amount of water, such an alkali metal-ammonium chromate double salt generally decomposes completely or predominantly to the ions of the salts from which they are built up, i.e. alkali metal, ammonium and chromate ions.

The thermal decomposition of the alkali metal ammonium chromate double salt is effected preferably at a temperature of 200 to 650° C., more preferably of 250 to 550° C., preferably within a period of 5 minutes to 300 minutes, more preferably of 30 minutes to 240 minutes. The thermal decomposition can be effected, for example, in a rotary tube furnace or in a fluidized bed. Particular preference is given to using an indirectly heatable reactor, for example an indirectly heatable rotary tube furnace.

The thermal decomposition of the alkali metal ammonium chromate double salt in step a) is associated with the release of ammonia, as illustrated by way of example by the two idealized reaction equations (6) and (7) for sodium ammonium chromate double salts:

4NaNH₄CrO₄*2H₂O→2Na₂CrO₄+Cr₂O₃+N₂+13H₂O+2NH₃ (6)

8 Na_{0.5}(NH₄)_{1.5}CrO₄→2Na₂CrO₄+3Cr₂O₃+3N₂+15H₂O+6NH₃ (7)

More preferably, the process according to the invention is operated in such a way that the ammonia released in the thermal decomposition of the alkali metal ammonium chromate double salt is recovered as a gas or aqueous solution and used again for the preparation of the alkali metal ammonium chromate double salt. The ammonia gas released is preferably condensed in the form of an aqueous ammonia solution and then used again for the preparation of the alkali metal ammonium chromate double salt, either directly as ammonia solution or optionally after splitting again into gaseous ammonia and water.

The decomposition product obtained after step a) does not yet meet the demands made on a chromium(III) oxide which is to be used as a colour pigment, abrasive, and starting material for the production of high-temperature-resistant materials, chromium metal and chromium-containing high-performance alloys. Further process steps are needed in order to obtain a high-quality end product.

### Step b)

The decomposition product obtained after step a) is preferably cooled, preferably taken up in water to form a mother liquor and washed once or more than once, preferably with water or an aqueous medium. After each wash, the solids are preferably removed from the liquid to form a solid and washing water.

For the solid/liquid separation, the person skilled in the art is aware of a multitude of suitable units and processes. It is unimportant whether the washing and solid/liquid separation are effected continuously or batchwise. It is likewise unimportant whether they are performed under pressure or with reduced pressure.

In the case of the continuous filtration and washing units, for example, vacuum drum filters or vacuum belt filters are particularly preferred. Among the batchwise filtration and washing units, filter presses are particularly preferred.

In order to improve the filtration or washing properties of the thermal decomposition product of the alkali metal ammonium chromate double salt, it may be advantageous to establish a pH of 4 to 7 in the washing water. This can be accomplished, for example, by adding a small amount of acid to the water to give an aqueous medium, preference being given to using organic low molecular weight acids, for example formic acid or acetic acid. These organic acids have the advantage that—if residues remain on the washed thermal decomposition product—they are combusted in the course of later calcination and do not remain as an impurity in the calcined product. However, it may also be advantageous when flocculants or flocculating aids are used in the filtration or washing. The use of organic flocculants or flocculating aids is particularly preferred because they are combusted in later calcination and do not remain as an impurity in the calcined product.

The moist filtercake obtained after washing can either be sent directly to the calcination in step c) or dried beforehand. For the drying step, the person skilled in the art is aware of a multitude of suitable units. Mention shall be made at this point merely of channel dryers, belt dryers, stage dryers, roll dryers, drum dryers, tubular dryers, paddle dryers, spray dryers (atomization dryers with plates or nozzles), fluidized bed dryers or batchwise staged chamber dryers. The moist filtercake is preferably sent directly to the calcination.

Further use of the collected mother liquors and washing waters is discussed in more detail below.

### Step c)

The thermal treatment at elevated temperature, i.e. the calcination, in step c) is effected at a temperature of 700 to 1400° C., more preferably of 800 to 1300° C., preferably within a period of more than 20 minutes, more preferably of more than 30 minutes. For calcination at such high temperatures, the person skilled in the art is aware of a multitude of suitable apparatus. Mention shall be made at this point merely of circular hearth furnaces, rotary tube furnaces, fluidized bed reactors or batchwise chamber furnaces. The calcination is preferably effected in a directly heated rotary tube furnace. The residence time of the material to be calcined is, according to the configuration and length of the furnace, preferably 30 minutes to 4 hours. The calcination is effected preferably under air or in an atmosphere composed of pure oxygen, or in an atmosphere composed of air enriched with oxygen.

The calcination in step c) is effected preferably in a different furnace from the decomposition in step a).

The washed decomposition product obtained after step b), which is calcined in step c), does not have a tendency to adhere, and so calcination is possible without any problem.

In a particularly preferred variant of the process according to the invention, the thermal decomposition of the alkali metal ammonium chromate double salt and/or the calcination is preceded by addition of one or more alkali metal halides or ammonium halides or alkaline earth metal halides, especially the fluorides, chlorides, bromides or iodides of sodium or potassium or ammonium, or alkali metal hydroxides, especially sodium hydroxide, or potassium hydroxide, or chromic acid, in an amount of 0.01% by weight to 3.0% by weight, especially of 0.02% by weight to 1.0% by weight, based on the alkali metal ammonium chromate double salt used. Such additions allow the performance properties to be influenced, especially the increase in the bulk density of the resulting chromium(III) oxide.

The chromium(III) oxide obtained after the calcination in step c) is preferably cooled and optionally ground. In a particularly preferred variant of the process according to the invention, the calcined product is leached with water, which gives rise to a mother liquor, and washed analogously to the procedure in step b) and then dried again. This allows water-soluble impurities (water-soluble salts) still present in the chromium(III) oxide—essentially alkali metal chromate, especially sodium chromate, which has formed as a result of oxidation of chromium(III) oxide at high temperatures—to be washed out by known processes in one or more stages with water or aqueous media, and the solids to be removed from the liquid. Preferred embodiments are as already specified for the washing in step b).

The chromium(III) oxide generally has good filtration and washing properties, such that the adjustment of the pH or the addition of a flocculant or flocculating aid is unnecessary. The moist chromium(III) oxide obtained after the solid/liquid separation is then dried. The dried chromium(III) oxide is then preferably dispensed directly, or optionally ground before being dispensed.

For the drying, the units already mentioned above can be used. According to the drying unit selected, it may be necessary for another grinding step to follow. However, even when the calcined product is not washed and dried, grinding may be advantageous. The calcined and optionally washed and dried product is preferably subjected to grinding. Suitable for this purpose are grinding units of different design, for example roll mills, pan mills, pendulum mills, hammer mills, pin mills, turbo mills, ball mills or jet mills. When the calcined product has been washed, it is particularly advantageous to use a grinding dryer, in which drying and grinding are effected in only one operation. The selection of the suitable grinding units is guided by factors including the particular field of use for the chromium(III) oxide prepared.

When the calcined chromium(III) oxide or the thermal decomposition product of the alkali metal ammonium chromate double salt is washed, the particular mother liquor and the particular washing water in both cases comprise essentially alkali metal chromate and/or alkali metal dichromate. These two substances of value can be recycled back into the production process, by using them, for example, for the preparation of alkali metal dichromate or—most preferably—for the preparation of an alkali metal ammonium chromate double salt, especially as described below. More preferably, mother liquors and washing waters which are obtained in the washing of the thermal decomposition product and/or calcination product are used again for the preparation of alkali metal dichromate or of an alkali metal ammonium chromate double salt, most preferably for the preparation of an alkali metal ammonium chromate double salt.

The chromium(III) oxide prepared by the process according to the invention is highly pure. It is consequently outstandingly suitable for metallurgical purposes, such as the production of chromium metal or chromium-containing high-performance alloys, especially by reduction in the presence of aluminium metal via the aluminothermic process, and for the production of high-temperature-resistant materials, but it can also be used as a colour pigment for pigment applications, since it also has a low content of water-soluble salts.

The invention also comprises the use of the chromium(III) oxide prepared by the process according to the invention as a colour pigment, abrasive, and starting material for the production of high-temperature-resistant materials, chromium metal or chromium-containing high-performance alloys, especially by reduction in the presence of aluminium metal via the aluminothermic process.

It is preferred that the alkali metal ammonium chromate double salt used is prepared by adding NH₃, preferably in a 1.0- to 5.0-fold, more preferably in a 1.4- to 4.5-fold, molar excess, based on alkali metal dichromate, especially M₂Cr₂O₇ in which M is Na or K, especially Na, preferably at a temperature of 55 to 95° C., to give an aqueous solution of alkali metal dichromate, especially M₂Cr₂O₇.

The invention further relates to a process for preparing alkali metal ammonium chromate double salts of the formula

Mₓ(NH₄)_{y}CrO₄

or hydrates thereof, in which
M is Na or K,
x is from 0.1 to 0.9, preferably from 0.4 to 0.7,
y is from 1.1 to 1.9, preferably from 1.3 to 1.6, and the sum of x and y is 2, characterized in that NH₃ is added to an aqueous solution of M₂Cr₂O₇, preferably in a 1.0- to 5.0-fold, more preferably in a 1.4- to 4.5-fold, molar excess based on M₂Cr₂O₇, at a temperature of 55 to 95° C.

S. W. Johnson “Chemische Notizen”, Journal für praktische Chemie, Vol. 62, pages 261-264 prepares a compound of the formula K(NH₄)Cr₂O₇ by reaction of NH₃ and K₂Cr₂O₇ under cold conditions.

The use of alkali metal ammonium chromate double salts, especially sodium ammonium chromate double salts, for preparation of high-purity, low-sulphur chromium(III) oxide has some important advantages over the processes described in the prior art. For instance, the thermal decomposition of alkali metal ammonium chromate double salts, more particularly sodium ammonium chromate double salts, unlike the thermal decomposition of ammonium dichromates, proceeds in no way violently, i.e. not explosively. The reaction can therefore be controlled and managed significantly better. The decomposition product obtained after the thermal decomposition and the product obtained after the calcination are notable for significantly higher bulk density than chromium(III) oxide which has been obtained by the thermal decomposition of ammonium dichromate. As a consequence of these two phenomena, the chromium(III) oxide obtained after the thermal decomposition of alkali metal ammonium chromate double salts, especially sodium ammonium chromate double salts, also has a significantly lesser tendency to dusting, which is very advantageous in operating terms. A further advantage of the process according to the invention is that alkali metal chromate and/or alkali metal dichromate form as by-products which can be recycled back into the preparation process without any problem. The chromium(III) oxide obtained by the process according to the invention is highly pure. It is low in sulphur per se, because no sulphur compounds are introduced into the production process. In addition, it is low in alkali metals. Chromium(III) oxides “low in sulphur” in the context of this invention are considered to be those which have a sulphur content of less than 200 ppm, preferably less than 50 ppm, most preferably less than 40 ppm. Chromium(III) oxides “low in alkali metals” in the context of this invention are considered to be those which have an alkali metal content—calculated as alkali metal—of less than 1500 ppm, preferably less than 500 ppm.

The invention is illustrated in detail by the examples which follow, without any intention that this should restrict the invention.

### EXAMPLES

### Preparation of the Sodium Ammonium Chromate Double Salts

At 60° C., a 70% solution of sodium dichromate dihydrate (Na₂Cr₂O₇*2H₂O) was prepared by dissolution in water. Then 2.7 times the molar amount of ammonia in relation to sodium dichromate dihydrate was added dropwise in the form of a 25% aqueous ammonia solution, in the course of which the temperature was kept at at least 60° C. and the sodium ammonium chromate double salt precipitated out in the above-described crystal structure. Finally, the warm suspension was filtered at 60° C., and the filtercake was washed with 99% ethanol and dried to constant weight at 100° C. Analysis of the resulting solids gave an ammononium:sodium ratio of 2.61 and, taking account of the conditions x+y=2, y=1.45 and x=0.55, and so the real composition of the sodium ammonium chromate double salt was Na_{0.55}(NH₄)_{1.45}CrO₄.

The sodium ammonium chromate double salt prepared in this way was used as the starting material for Examples 1 to 4 described below.

### Example 1

The above-described sodium ammonium chromate double salt was thermally decomposed at 300° C. for 3 hours, and the thermal decomposition product was leached with water at 90° C. Subsequently, the solids were removed from the mother liquor and washed. The moist filtercake was first dried and then calcined at 1200° C. for 2 hours. The calcined product was leached again with water at 90° C. Subsequently, the solids were removed from the mother liquor and washed, and the moist filtercake was dried. The overall yield of chromium(III) oxide in relation to the Cr(VI) present in the starting compound was 60.5% and the chromium(M) oxide had a sodium content—calculated as sodium metal—of 150 ppm.

### Example 2

The above-described sodium ammonium chromate double salt was thermally decomposed at 400° C. for 90 minutes, and thermal decomposition product was leached with water at 90° C. Subsequently, the solids were removed from the mother liquor and washed. The moist filtercake was first dried and then calcined at 1100° C. for 3 hours. The calcined product was leached again with water at 90° C. Subsequently, the solids were removed from the mother liquor and washed, and the moist filtercake was dried. The overall yield of chromium(III) oxide in relation to the Cr(VI) present in the starting compound was 56.2% and the chromium(III) oxide had a sodium content—calculated as sodium metal—of 850 ppm.

### Example 3

The above-described sodium ammonium chromate double salt was thermally decomposed at 300° C. for 60 minutes, then the temperature was increased to 450° C. for a period of 2.5 hours and held at 450° C. for a further 60 minutes. The thermal decomposition product was leached with water at 90° C. Subsequently, the solids were removed from the mother liquor and washed. The moist filtercake was first dried and then calcined at 950° C. for 3 hours. The calcined product was leached again with water at 90° C. Subsequently, the solids were removed from the mother liquor and washed, and the moist filtercake was dried. The overall yield of chromium(III) oxide in relation to the Cr(VI) present in the starting compound was 59.0% and the chromium(III) oxide had a sodium content—calculated as sodium metal—of 1400 ppm.

### Example 4

The above-described sodium ammonium chromate double salt was thermally decomposed at 500° C. for 45 minutes, and the thermal decomposition product was leached with water at 90° C. Subsequently, the solids were removed from the mother liquor and washed. The moist filtercake was first dried and then calcined at 1150° C. for 3 hours. The calcined product was leached again with water at 90° C. Subsequently, the solids were removed from the mother liquor and washed, and the moist filtercake was dried. The overall yield of chromium(III) oxide in relation to the Cr(VI) present in the starting compound was 66.7% and the chromium(III) oxide had a sodium content—calculated as sodium metal—of 1100 ppm.

What is claimed is:

1. Process for preparing chromium(III) oxide, comprising the steps of:
a) decomposing an alkali metal ammonium chromate double salt at a temperature of 200 to 650° C., especially of 250 to 550° C.,
b) washing the decomposition product obtained after a) and
c) calcining the product obtained after b) at a temperature of 700 to 1400° C., especially of 800 to 1300° C., characterized in that the alkali metal ammonium chromate double salt comprises a sodium ammonium chromate double salt which has a molar ammonium:sodium ratio of ≧2.

2. Process according to claim 1, characterized in that the alkali metal ammonium chromate double salt comprises a hydrate.

3. Process according to one or more of claims 1 to 2, characterized in that the calcined product is washed after step c).

4. Process according to one or more of claims 1 to 3, characterized in that the calcined and optionally washed and optionally dried product is subjected to grinding.

5. Process according to one or more of claims 1 to 4, characterized in that the thermal decomposition of the alkali metal ammonium chromate double salt in step a) and/or the calcination in step c) is preceded by addition of one or more alkali metal halides or ammonium halides or alkaline earth metal halides, especially the fluorides, chlorides, bromides or iodides of sodium or potassium or ammonium, or alkali metal hydroxides, especially sodium hydroxide, or potassium hydroxide, or chromic acid, in an amount of 0.01% by weight to 3.0% by weight, especially of 0.02% by weight to 1.0% by weight, based on the alkali metal ammonium chromate double salt used.

6. Process according to one or more of claims 1 to 5, characterized in that the ammonia released in the thermal decomposition of the alkali metal ammonium chromate double salt is recovered as a gas or aqueous solution and used again for the preparation of the alkali metal ammonium chromate double salt.

7. Process according to one or more of claims 1 to 6, characterized in that NH₃ is added to an aqueous solution of an alkali metal dichromate.

8. Use of chromium(III) oxide prepared according to one or more of claims 1 to 7 as a colour pigment, abrasive, and starting material for the production of high-temperature-resistant materials, chromium metal or chromium-containing high-performance alloys.

9. Process for preparing alkali metal ammonium chromate double salts of the formula
Mₓ(NH₄)_{y}CrO₄
or hydrates thereof, in which
M is Na or K,
x is from 0.1 to 0.9, preferably from 0.4 to 0.7,
y is from 1.1 to 1.9, preferably from 1.3 to 1.6, and the sum of x and y is 2, characterized in that NH₃ is added to an aqueous solution of M₂Cr₂O₇ at a temperature of 55 to 95° C.
